(19) United States
(12) Patent Application Publication
(10) Pub. No.: US 2024/0066694 A1
(43) Pub. Date: Feb. 29, 2024

(54) ROBOT CONTROL SYSTEM, ROBOT CONTROL METHOD, AND ROBOT CONTROL PROGRAM

(71) Applicant: KABUSHIKI KAISHA YASKAWA DENKI, Kitakyushu-shi (JP)

(72) Inventor: Tatsuya KITTAKA, Kitakyushu-shi (JP)

(73) Assignee: KABUSHIKI KAISHA YASKAWA DENKI, Kitakyushu-shi (JP)

(21) Appl. No.: 18/448,371

(22) Filed: Aug. 11, 2023

(30) Foreign Application Priority Data
Aug. 26, 2022 (JP) 2022-134639

(51) Int. Cl. B25J 9/16

(52) U.S. Cl. CPC B25J 9/1661; B25J 9/1697

(57) ABSTRACT

A robot control system includes processing circuitry that generates an inquiry for a user while a robot is executing a task, identifies an action of the user in response to the inquiry using a sensor, complements at least part of the task based on the identified action, and controls the robot such that the robot executes the complemented at least part of the task.

### CROSS-REFERENCE TO RELATED APPLICATIONS

The present application is based upon and claims the benefit of priority to Japanese Patent Application No. 2022-134639, filed Aug. 26, 2022, the entire contents of which are incorporated herein by reference.

### BACKGROUND OF THE INVENTION

### Field of the Invention

The present invention relates to a robot control system, a robot control method, and a robot control program.

### Description of Background Art

Japanese Patent No. 5549749 describes a robot teaching system for suppressing an increase in user operation burden. The entire contents of this publication are incorporated herein by reference.

### SUMMARY OF THE INVENTION

According to one aspect of the present invention, a robot control system includes processing circuitry that generates an inquiry for a user while a robot is executing a task, identifies an action of the user in response to the inquiry using a sensor, complements at least part of the task based on the identified action, and controls the robot such that the robot executes the complemented at least part of the task.

According to another aspect of the present invention, a robot control system includes processing circuitry that generates an inquiry for a user about a document indicating a task to be executed by a robot, identifies the document presented by the user from an image captured by a camera, defines the task based on the identified document, and controls the robot such that the robot executes the defined task.

According to yet another aspect of the present invention, a robot control method includes generating, by processing circuitry of a robot control system, an inquiry for a user while a robot is executing a task; identifying, by the processing circuitry of the robot control system, an action of the user in response to the inquiry using a sensor; complementing, by the processing circuitry of the robot control system, at least part of the task based on the identified action; and controlling, by the processing circuitry of the robot control system, the robot such that the robot executes the complemented at least part of the task.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates an example of an application of a robot control system;

FIG. 2 illustrates an example of a hardware structure of a computer used for the robot control system;

FIG. 3 is a flowchart illustrating an example of processing in the robot control system;

FIG. 4 is a flowchart illustrating an example of processing defining a task;

FIG. 5 is a flowchart illustrating an example of processing complementing a workpiece;

FIG. 6 is a flowchart illustrating an example of processing complementing a target position;

FIG. 7 illustrates an example of a document;

FIG. 8 illustrates a scene related to identification of a document;

FIG. 9 illustrates a scene related to complementation of a workpiece;

FIG. 10 illustrates a scene related to complementation of a target position;

FIG. 11 illustrates a scene related to the complementation of the target position; and

FIG. 12 illustrates a scene related to the complementation of the target position.

### DETAILED DESCRIPTION OF THE EMBODIMENTS

Embodiments will now be described with reference to the accompanying drawings, wherein like reference numerals designate corresponding or identical elements throughout the various drawings.

### Structure of System

In one example, a robot control system according to an embodiment of the present invention is illustrated as a structural element of a robot system 1. The robot system 1 is a mechanism for automating a given work by causing a robot to execute an operation for achieving a given purpose.

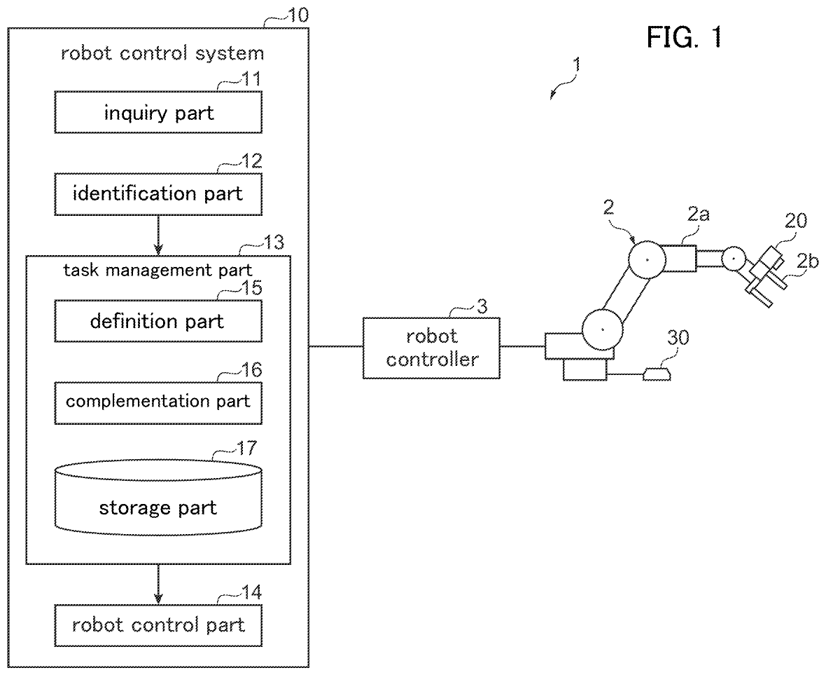

FIG. 1 illustrates an example of a structure of the robot system 1 and an example of application of the robot control system. In this example, the robot system 1 includes a robot control system 10, at least one robot 2, and at least one robot controller 3 corresponding to the at least one robot 2. FIG. 1 illustrates one robot 2 and one robot controller 3 and illustrates a structure in which one robot 2 is connected to one robot controller 3. As another example, the robot control system 10 may be connected to multiple pairs of robots 2 and robot controllers 3. Or one robot controller 3 may be connected to multiple robots 2. A communication network used to connect devices may be a wired network or a wireless network. The communication network may include at least one of the Internet and an intranet. Or the communication network may simply be realized by one communication cable.

In at least some situations, the robot control system 10 is a computer system for causing the robot 2 to autonomously operate. The robot control system 10 executes a given operation to generate a command signal for controlling the robot 2. In one example, the command signal includes data for controlling the robot 2, for example, includes a path indicating a trajectory of the robot 2. The trajectory of the robot 2 refers to a path of motion of the robot 2 or a structural element of the robot 2. For example, the trajectory of the robot 2 can be a trajectory of a front end part. The robot control system 10 transmits the generated command signal to the robot controller 3.

The robot controller 3 is a device that, according to the command signal from the robot control system 10, causes the robot 2 to operate. In one example, the robot controller 3 calculates joint angle target values (angle target values of joints of the robot 2) for matching a position and a posture of the front end part to a target value indicated by the command signal, and controls the robot 2 according to the angle target values.

The robot 2 is a device or machine that works on behalf of a human. In one example, the robot 2 is a multi-axis serial link type vertical articulated robot. The robot 2 includes a manipulator (2a) and an end effector (2b), which is a tool attached to a front end of the manipulator (2a). The robot 2 can execute various processes using the end effector (2b). The robot 2 can freely change a position and a posture of the end effector (2b) within a given range. The robot 2 may be a 6-axis vertical articulated robot, or a 7-axis vertical articulated robot with one redundant axis added to 6 axes.

The robot 2 operates based on control by the robot control system 10 to execute a given task. A task in the present disclosure refers to a series of processes to be executed by the robot 2 in order to achieve a certain purpose. The robot 2 executes a task, and thereby, a result desired by a user of the robot system 1 is obtained. For example, a task is set up to process some workpiece. Examples of tasks include “picking up a workpiece and placing it on a conveyor,” “grabbing a workpiece and attaching it to another structure,” and “spray painting a workpiece.” A workpiece refers to a tangible object processed by the robot 2.

The robot control system 10 supports teaching from a user to the robot 2. Teaching refers to a work in which a work to be executed is directly or indirectly conveyed to a robot. When a user teaches a robot via a user interface such as a programming pendant, a keyboard, a mouse, or a dedicated controller, the user needs to memorize complicated commands that are difficult to intuitively understand or learn complicated operation methods of a user interface. Therefore, a lot of time is spent before the user becomes proficient in teaching the robot. In addition, a cost of introducing a dedicated user interface is incurred.

The robot control system 10 executes teaching to the robot 2 based on interactions with the user. The robot control system 10 executes an inquiry to the user while the robot is executing a task. That the robot 2 is executing a task means that the robot 2 has started to operate based on a predetermined program. Therefore, the robot control system 10 executes an inquiry to the user when the robot 2 is in an online state. That the robot 2 is executing a task includes a case where the robot 2 is in a standby posture. An inquiry to a user refers to a process of asking the user to input an instruction. The robot control system identifies a user action in response to an inquiry using a sensor. The robot control system 10 complements a part of a task based on the action and causes the robot 2 to execute the complemented task. An action refers to an expression resulting from behavior of the user. For example, an action is an expression perceivable through human vision or hearing. Examples of actions include gestures, production of sounds (such as clapping, and vocalization), and presentation of objects. An action indicates an instruction from the user. The robot control system 10 generates a task through interaction with the user while the robot 2 is executing a task. In one example, this mechanism enables the robot 2 to process a workpiece while flexibly adapting to a change in an environment of an actual workspace in which the robot 2 exists.

In the robot control system 10, for a teaching purpose, it is sufficient for the user to perform a predetermined action towards a sensor in the workspace. For a teaching purpose, the user does not need to operate a user interface. In one example, an action is similar to an ordinary movement of the user and does not require a special skill from the user. Therefore, the user can easily perform a predetermined action and more intuitively instruct the robot 2. Therefore, even a user who is unfamiliar with robot operation can easily teach a task to the robot 2. In contrast to teaching which is highly concrete and machine-centric, teaching in the robot control system 10 is abstract and human-centric.

Examples of sensors for identifying user actions include visual sensors such as cameras and auditory sensors such as microphones. In one example, the robot control system 10 uses a camera 20 and a speakerphone 30 as sensors. The camera 20 is an imaging device that captures surroundings of the end effector (2b). The camera 20 may be positioned on the manipulator (2a), for example, it may be attached near the front end of the manipulator (2a). The camera 20 moves in response to an operation of the robot 2. This movement can include a change in at least one of a position and a posture of the camera 20. The camera 20 may be provided at a place different from the robot 2 as long as it moves in response to an operation of the robot 2. The speakerphone 30 is a device that integrates a microphone and a speaker. The speakerphone 30 detects a sound around the robot 2 and outputs a voice to the user. The speakerphone 30 may be provided on a floor or positioned on the manipulator (2a).

FIG. 1 also illustrates an example of a functional structure of the robot control system 10. In one example, the robot control system 10 includes, as functional structural elements, an inquiry part 11, an identification part 12, a task management part 13, and a robot control part 14. The inquiry part 11 is a functional module that executes an inquiry to the user while the robot is executing a task. The identification part 12 is a functional module that identifies a user action in response to the inquiry using a sensor. The task management part 13 is a functional module that generates a task based on the action. In one example, the task management part 13 includes a definition part 15, a complementation part 16, and a storage part 17. The definition part 15 is a functional module that defines a task. The complementation part 16 is a functional module that complements a defined task and generates the task. The storage part 17 is a functional module that stores at least a part of a complemented task as a task part. The robot control part 14 is a functional module that controls the robot 2 such that the robot 2 executes a generated task.

Defining a task refers to a process of setting one or more robot operations that form a task. In one example, defining a task is a process of setting a part of a task, not the entire task. For example, the definition part 15 defines a task without setting at least one of a workpiece to be processed by the task and a target position of the task. Complementing a task refers to a process of setting an unset part of the task. A task is generated by complementing the task by the complementation part 16. For example, the definition part defines a task consisting of two instructions: “Place <Object A> at <Place P>” and “End the task when no object is found.” “Place˜ at . . . ” and “End the task when no object is found” in the instructions are task-related syntaxes. The definition part 15 defines a task based on the syntaxes. On the other hand, “Object A” and “Place P” in the instruction correspond to variables for which definition is pending as unset parts. The complementation part 16 sets these unset parts. For example, the complementation part 16 sets “Object A” to “a red object” and “Place P” to a specific place. When the place is expressed as a position (Xa, Ya) for convenience, the complementation part 16 generates a task by ultimately complementing “Put <Object A> at <Place P>” with “Put the red object at the position (Xa, Ya).”

The robot control system 10 can be realized by any kind of computer. The computer may be a general-purpose computer such as a personal computer or a server for business use or may be incorporated into a dedicated device that executes a specific process.

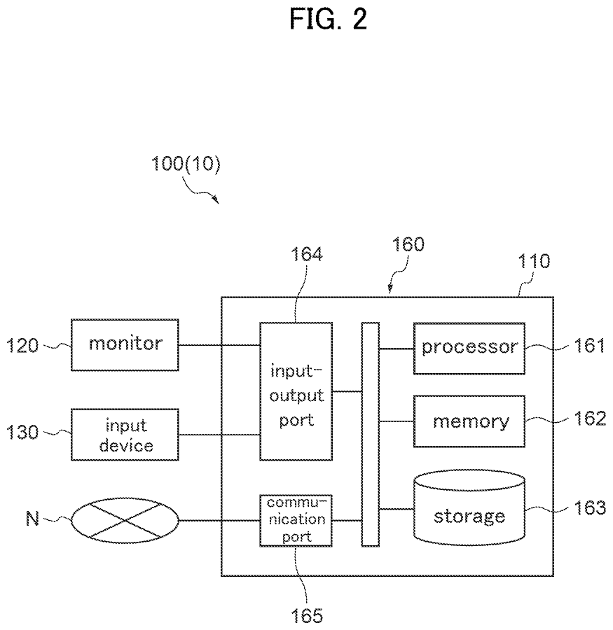

FIG. 2 illustrates an example of a hardware structure of a computer 100 used for the robot control system 10. In this example, the computer 100 includes a main body 110, a monitor 120, and an input device 130.

The main body 110 is a device that has a circuitry 160. The circuitry 160 includes at least one processor 161, a memory 162, a storage 163, an input-output port 164, and a communication port 165. The storage 163 records programs for constructing functional modules of the main body 110. The storage 163 is a computer-readable recording medium such as a hard disk, a nonvolatile semiconductor memory, a magnetic disk, or an optical disk. The memory 162 temporarily stores a program loaded from the storage 163, a calculation result of the processor 161, and the like. The processor 161 forms the functional modules by executing a program in cooperation with the memory 162. The input-output port 164 performs input or output of an electrical signal to or from the monitor 120 or the input device 130 according to a command from the processor 161. The input-output port 164 may perform input or output of an electrical signal to or from other devices such as the robot controller 3, the camera 20, the speakerphone 30, and the like. The communication port 165 performs data communication with other devices via a communication network (N) according to a command from the processor 161.

The monitor 120 is a device for displaying information output from the main body 110. For example, the monitor 120 is a device capable of displaying graphics, such as a liquid crystal panel.

The input device 130 is a device for inputting information to the main body 110. Examples of the input device 130 include operation interfaces such as a keypad, a mouse, and an operation controller.

The monitor 120 and the input device 130 may be integrated as a touch panel. For example, the main body 110, the monitor 120, and the input device 130 may be integrated like a tablet computer.

The functional modules of the robot control system 10 are realized by loading a robot control program to the processor 161 or the memory 162 and causing the processor 161 to execute the program. The robot control program contains codes for realizing the functional modules of the robot control system 10. The processor 161 operates the input-output port 164 and the communication port 165 according to the robot control program and performs reading and writing of data in the memory 162 or the storage 163.

The robot control program may be provided after being recorded on a non-temporary recording medium such as a CD-ROM, a DVD-ROM, or a semiconductor memory. Or the robot control program may be provided over a communication network as a data signal superimposed on a carrier wave.

### Robot Control Method

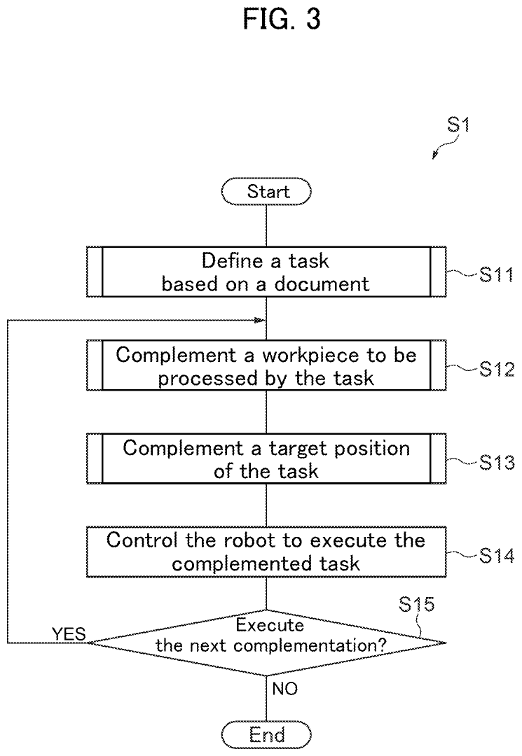

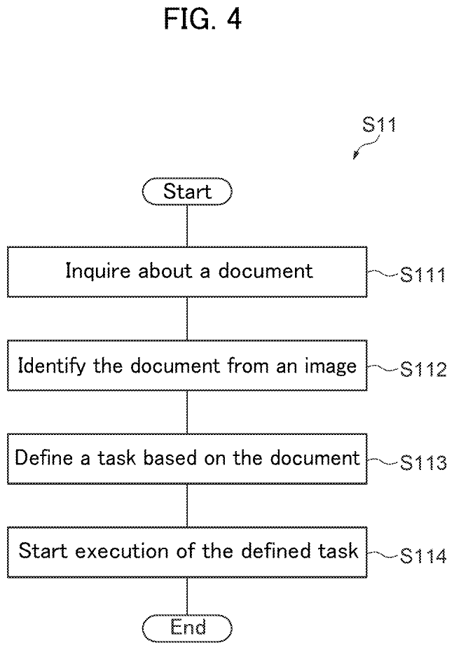

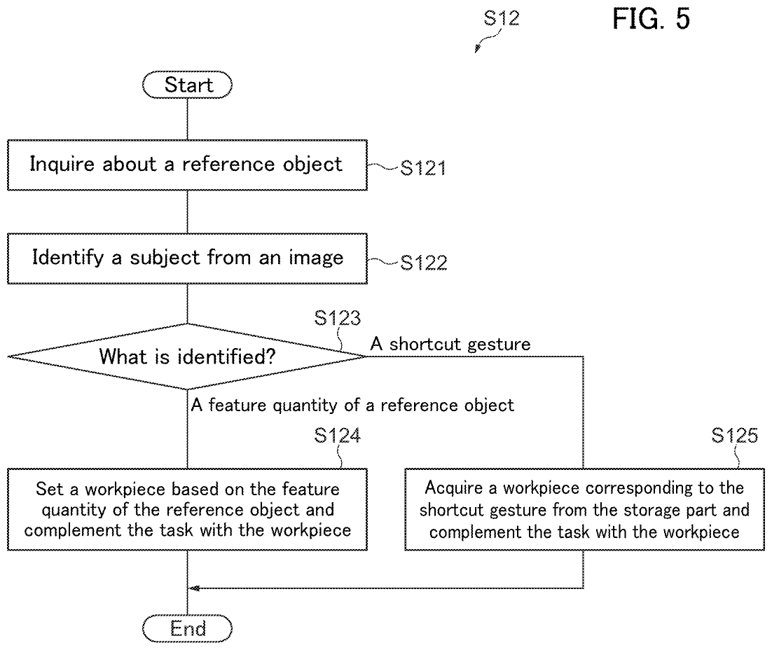

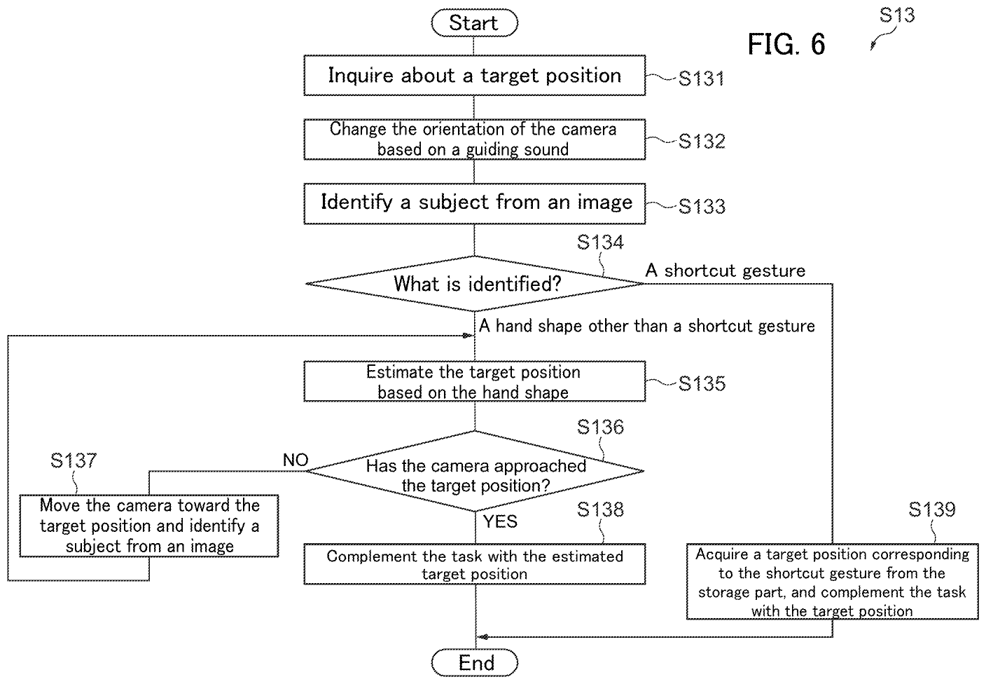

As an example of a robot control method according to the present disclosure, processing executed by the robot control system 10 is described with reference to FIGS. 3-6. FIG. 3 is a flowchart showing an example of the processing as processing flow (S1). That is, the robot control system 10 executes the processing flow (S1). FIGS. 4-6 are also each a flowchart illustrating details of a portion of the processing flow (S1). FIG. 4 illustrates an example of processing defining a task, FIG. 5 illustrates an example of processing complementing a workpiece, and FIG. 6 illustrates an example of processing complementing a target position.

In S11, the robot control system 10 defines a task based on a document. The document refers to a record of information that defines a task. Therefore, the document indicates a task. The document can also be said to be an instruction document for the robot 2. Task definition is described in detail with reference to FIG. 4.

In S111, the inquiry part 11 inquires the user about the document. The document inquiry refers to a process of asking the user to input a document. In one example, the inquiry part 11 causes the robot 2 to assume a predetermined inquiry posture, which is a posture corresponding to the inquiry. When the robot 2 assumes the inquiry posture, the inquiry part 11 may output a guidance voice from the speakerphone 30, such as “Please show me an instruction document.” In one example, the inquiry part 11 executes the inquiry after the robot 2 assumes the inquiry posture.

In S112, the identification part 12 identifies the document from an image captured by the camera 20. The user presents the document to the camera 20. The document may be described on a medium such as a board or a sheet or may be electronically displayed on a display device. Presenting a document is an example of a user action in response to an inquiry. In one example, the identification part 12 pre-stores a recognition target set for identifying a document from an image. A recognition target is information set in advance regarding a user action. The identification part 12 extracts the recognition target from an image and identifies the document based on the recognition target.

In S113, the definition part 15 defines a task based on the document. The definition part 15 sets at least one operation of the robot 2 that forms a task, according to a syntax indicated by the document. For example, the definition part 15 sets various parameters or conditions for the operation of the robot 2, such as an operation speed of the robot 2, and a task termination condition. At this stage, the task includes an unset part. The definition part 15 sets an operation of the robot 2 at a task start time, that is, an initial operation of the robot 2 in the task. The definition part 15 may output a voice from the speakerphone 30 indicating that a task has been defined.

In S114, the robot control part 14 starts executing the defined task. At this stage, the task as a whole is incomplete. However, an operation for starting the task has been set. Therefore, the robot control part 14 can start execution of the task. However, in order for the robot 2 to execute the entire task, the task is complimented by assigning a value to a variable indicated by the document. The complementation is executed in S12 and beyond.

Returning to FIG. 3, in S12, the robot control system 10 complements a workpiece to be processed by the defined task. In one example, the inquiry part 11 executes an inquiry to the user regarding a variable corresponding to the workpiece. Subsequently, the identification part 12 identifies a user action in response to the inquiry. Then, the complementation part 16 complements the task by assigning the workpiece to be processed by the robot 2 to the variable based on the action. Complementation of the task by a workpiece is described in detail with reference to FIG. 5.

In S121, the inquiry part 11 inquires the user about a reference object. The reference object refers to an object that indicates information required for identifying a workpiece. The reference object may be the same object as the workpiece to be processed or may be a different object from the workpiece. The inquiry about a reference object refers to a process of asking the user to input a reference object. In one example, the inquiry part 11 causes the robot 2 to assume a predetermined inquiry posture. When the robot 2 assumes the inquiry posture, the inquiry part 11 may output a guidance voice from the speakerphone 30, such as “Please show me a reference object.” In one example, the inquiry part 11 executes the inquiry after the robot 2 assumes the inquiry posture.

In S122, the identification part 12 identifies a subject from an image captured by the camera 20. In one example, the user presents a reference object towards the camera 20. The reference object may be a physical object, may be described on a medium such as a board or a sheet, or may be electronically displayed on a display device. Or, the user presents, to the camera, a shortcut gesture, which is set in advance for complementing a workpiece as a part of the task. The shortcut gesture is represented by a hand gesture, that is, a hand shape. Both presenting a reference object and using a shortcut gesture are examples of user actions in response to an inquiry. In one example, the identification part 12 pre-stores a recognition target set for identifying a subject from an image. The identification part 12 extracts either the reference object or a hand of the user as the recognition target from the image, and identifies a subject based on the recognition target. When a reference object is extracted, the identification part 12 identifies a feature quantity of the reference object as a user action. A feature quantity of a reference object is a physical quantity that indicates a feature or a property of the reference object. For example, a physical quantity may indicate a color, a shape, a texture, or an object type. When the hand of the user is extracted and the hand shape corresponds to a shortcut gesture, the identification part 12 identifies the shortcut gesture as a user action.

As illustrated in S123, the identification part 12 identifies either a feature quantity of a reference object or a shortcut gesture as a subject. When a feature quantity of a reference object is identified, the process proceeds to S124. When a shortcut gesture is identified, the process proceeds to S125.

In S124, the complementation part 16 sets a workpiece based on the feature quantity of the reference object and complements the task with the workpiece. That is, the complementation part 16 complements the workpiece as at least a part of the task. For example, the complementation part 16 complements the task by setting a workpiece such as a “red object” or a “T-shaped object” and assigning the workpiece to the variable of the document. The complementation part 16 may output a voice from the speakerphone 30 indicating that the task has been complemented with the workpiece.

In S125, the complementation part 16 acquires a workpiece stored in the storage part 17 as a task part corresponding to the shortcut gesture and complements the task with the workpiece. For example, the complementation part 16 complements the task by assigning the workpiece to the variable of the document. In this case, the task includes the task part. Similar to S124, the complementation part 16 may output a voice from the speakerphone 30 indicating that the task has been complemented with the workpiece.

Returning to FIG. 3, in S13, the robot control system 10 complements a target position of the task. The target position of the task is a position at which processing with respect to the workpiece is completed. For example, when the task is a pick-and-place operation, the target position is a position where the workpiece grasped by the robot 2 is to be placed. In one example, the inquiry part 11 executes an inquiry to the user regarding a variable corresponding to a target position. Subsequently, the identification part 12 identifies a user action in response to the inquiry. Then, the complementation part 16 complements the task by assigning the target position to the variable based on the action. Complementation of the task by a target position is described in detail with reference to FIG. 6.

In S131, the inquiry part 11 inquires the user about a target position. The inquiry about a target position refers to a process of asking the user to input a target position. In one example, the inquiry part 11 causes the robot 2 to assume a predetermined inquiry posture. When the robot 2 assumes the inquiry posture, the inquiry part 11 may output a guidance voice from the speakerphone 30, such as “Please tell me a target position.” In one example, the inquiry part 11 executes the inquiry after the robot 2 assumes the inquiry posture.

In S132, the identification part 12 changes an orientation of the camera 20 based on a guiding sound. In one example, the user emits a guiding sound by clapping his hands or producing a sound as a preceding action performed before an action indicating a target position. The identification part 12 acquires the guiding sound via the speakerphone 30 and estimates a direction in which the guiding sound is emitted. Then, the identification part 12 controls the robot 2 such that the camera 20 mounted on the robot 2 is oriented in that direction. In one example, the identification part 12 generates, by planning, a path of the robot 2 for changing the orientation of the camera 20, and outputs a command signal indicating the path to the robot controller 3. The robot controller 3 controls the robot 2 according to the command signal. The robot 2 moves along the path, and as a result, the camera 20 moves so as to face the direction in which the guiding sound is emitted.

In S133, the identification part 12 identifies a subject from an image captured by the camera 20 that has moved. In one example, the user faces the camera 20 and points to a target position with his/her hand. Or, the user presents, to the camera, a shortcut gesture, which is set in advance for complementing a target position as a part of the task. Both a hand shape indicating a target position and using a shortcut gesture are examples of user actions in response to an inquiry. In one example, the identification part 12 pre-stores a recognition target set for identifying a subject from an image. The identification part 12 extracts the hand of the user from the image as the recognition target, and identifies a subject based on the recognition target. When the hand shape corresponds to a shortcut gesture, the identification part 12 identifies the shortcut gesture as a user action. When the hand shape does not correspond to a shortcut gesture, the hand shape is identified as a user action.

As illustrated in S134, the identification part 12 identifies either a shortcut gesture or a hand shape other than a shortcut gesture as a subject.

When a hand shape other than a shortcut gesture is identified in S134, the process proceeds to S135. In S135, the identification part 12 estimates the target position based on the hand shape. In one example, the identification part 12 sets a reference axis with respect to the hand shape and estimates the target position based on the reference axis. For example, the identification part 12 sets a reference axis along a longitudinal direction of the hand shape and estimates an intersection between the reference axis and a region projected in the image as the target position. The region intersecting the reference axis corresponds to, for example, a place where the workpiece is to be placed.

In S136, the identification part 12 determines whether or not the camera 20 has approached the target position. In one example, the identification part 12 calculates a distance between the camera 20 and the target position, and executes the determination based on the distance. The identification part 12 may calculate the distance based on a depth image provided by the camera 20. Or the identification part 12 may calculate the distance based on an image from the camera 20 and depth information provided separately from the image. When the calculated distance is equal to or less than a given threshold, the identification part 12 determines that the camera 20 has approached the target position. On the other hand, when the calculated distance is greater than the threshold, the identification part 12 determines that the camera 20 has not approached the target position.

When it is determined that the camera 20 has not approached the target position (NO in S136), the process proceeds to S137. In S137, the identification part 12 controls the robot 2 such that the camera 20 is moved toward the target position and identifies a subject from an image captured by the camera 20 that has moved. In one example, the identification part 12 generates, by planning, a path of the robot 2 for bringing the camera closer to the hand of the user, which is the recognition target, and outputs a command signal indicating the path to the robot controller 3. The robot controller 3 controls the robot 2 according to the command signal. The robot 2 moves along the path, and as a result, the camera 20 approaches the hand of the user and the target position. The identification part 12 may cause the robot 2 to operate such that the recognition target (hand of the user) is positioned at a center of a field of view of the camera 20. The identification part 12 extracts the recognition target from an image captured by the camera that has approached the recognition target and identifies the hand shape indicating the target position as a user action.

After S137, the process returns to S135, and the identification part 12 estimates a target position for a newly identified hand shape. The processing of S135-S137 is repeated until the camera 20 approaches the target position.

When it is determined that the camera 20 has approached the target position (YES in S136), the process proceeds to S138. In S138, the complementation part 16 complements the task with the target position estimated based on the hand shape. That is, the complementation part 16 complements the target position as at least a part of the task. For example, the complementation part 16 complements the task by assigning the target position to the variable of the document. The complementation part 16 may output a voice from the speakerphone 30 indicating that the task has been complemented with the target position.

In S134, when a shortcut gesture is identified, the process proceeds to S139. In S139, the complementation part 16 acquires a target position stored in the storage part 17 as a task part corresponding to the shortcut gesture and complements the task with the target position. For example, the complementation part 16 complements the task by assigning the target position to the variable of the document. In this case, the task includes the task part. Similar to S138, the complementation part 16 may output a voice from the speakerphone 30 indicating that the task has been complemented with the target position.

Returning to FIG. 3, in S14, the robot control part 14 controls the robot 2 to execute the complemented task. In one example, the robot control part 14 generates, by path planning, a path for searching the workpiece in the workspace, and outputs a command signal indicating the path to the robot controller 3. The robot controller 3 controls the robot 2 according to the command signal. The robot 2 moves along the path and searches for the workpiece. When the workpiece is found, the robot control part 14 generates, by planning, a path for executing the complemented task with respect to the workpiece, and outputs a command signal indicating the new path to the robot controller 3. The robot controller 3 controls the robot 2 according to the command signal. The robot 2 moves along the new path, and as a result, the robot 2 processes the workpiece. For example, the robot 2 executes a pick-and-place operation to move the workpiece to the target position. When there are multiple workpieces in the workspace, the robot control part 14 can repeat workpiece searching and execution of the task with respect to a found workpiece.

In one example, the complementation part 16 stores at least a part of the complemented task as a task part in the storage part 17. For example, the task part may be a complemented workpiece or target position or may be the entire task.

As illustrated in S15, after executing the complemented task and processing one or more workpieces, the robot control system 10 may execute a next complementation. For example, the robot control system 10 repeatedly executes necessary processing according to a new object to be complemented. As an example, when a workpiece is newly complemented, the process returns to S12. In S12 to be repeated, the robot control system executes an inquiry to the user regarding a variable corresponding to a workpiece, identifies a user action in response to the inquiry, and complements the task by assigning the workpiece to the variable based on the action. The workpiece assigned to the variable may be the same as or different from the workpiece used in the previous complementation. In S13 to be repeated, the robot control system 10 executes an inquiry to the user regarding a variable corresponding to a target position, identifies a user action in response to the inquiry, and complements the task by assigning the target position to the variable based on the action. The target position assigned to the variable may be the same as or different from the target position used in the previous complementation. In S14 to be repeated, the robot control part 14 controls the robot 2 to execute the newly complemented task. As another example, when the target position is newly complemented, the process returns to S13 and the robot control system 10 executes S13 and S14.

The entire processing flow (S1) may be repeatedly executed. That is, the robot control system 10 may define a next task based on another document (S11), complement the next task (S12, S13), and control the robot 2 to execute the complemented next task (S14).

In the processing flow (S1), the identification part 12 may execute an additional inquiry to the user regarding whether to confirm the identified action and may confirm the action based on a response from the user to the additional inquiry. The additional inquiry is a process that gives the user an opportunity to reconsider an action to be entered into the robot control system 10. In one example, the identification part 12 extracts a first shape of a hand from a first image of the camera 20 and identifies the first shape as an action. For example, the first shape is a hand shape pointing at a target position. The identification part 12 executes an additional inquiry to the user regarding whether to confirm the action. For example, the identification part 12 outputs a voice from the speakerphone 30 for the additional inquiry. The identification part 12 extracts a second shape of a hand in response to the additional inquiry from a second image captured by the camera 20 after the first image. Then, the identification part 12 confirms the identified action in response to the second shape. The complementation part 16 complements the task based on the confirmed action. For example, the complementation part 16 complements the target position as at least a part of the task based on the action.

In relation to S132, the identification part 12 may change the orientation of the camera 20 based on a preceding action detected by the camera 20 rather than by the speakerphone 30. For example, the user faces the camera 20 and points to a target position with his/her hand or finger. Based on the gesture, the identification part 12 controls the robot 2 such that the camera 20 is oriented in the indicated direction.

S132 can be executed again at any time in S13. For example, in S133 and beyond, in response to that the user has emitted a guiding sound to re-specify a target position, the process in S13 may return to S132. In this case, the identification part 12 changes the orientation of the camera 20 again based on the guiding sound. Then, the processing of S133 and beyond is executed again.

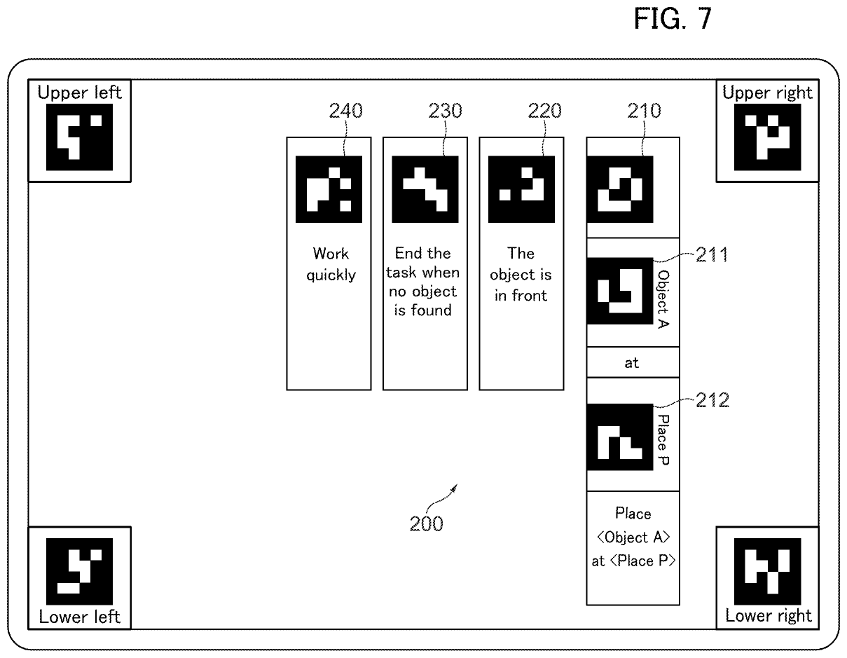

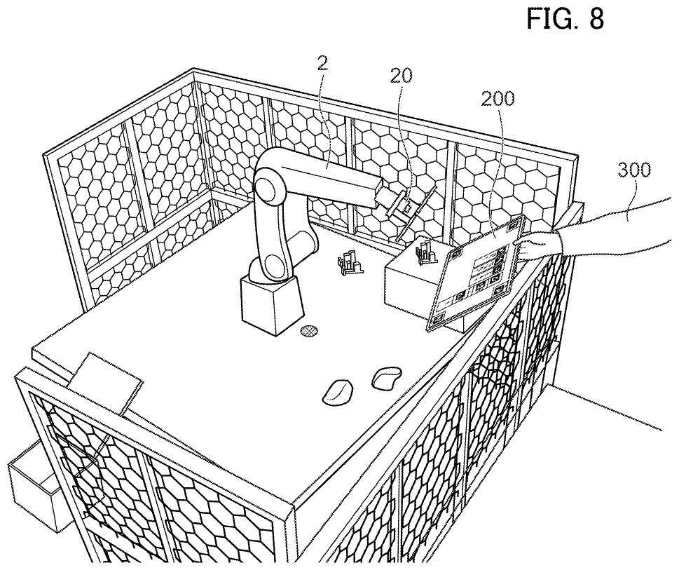

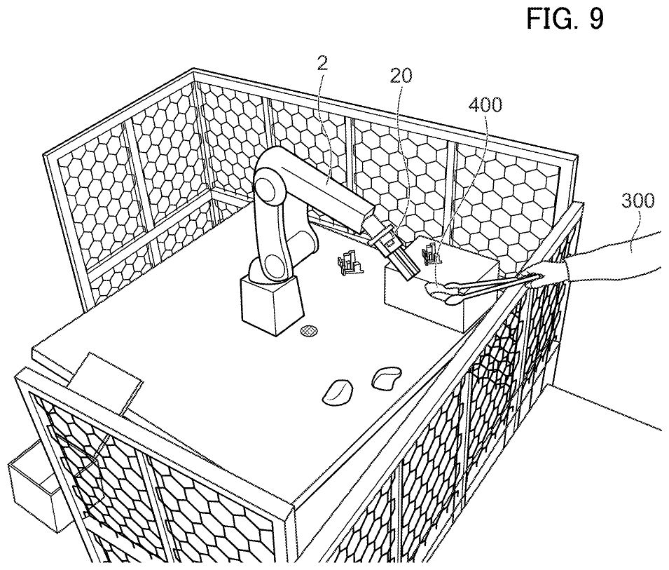

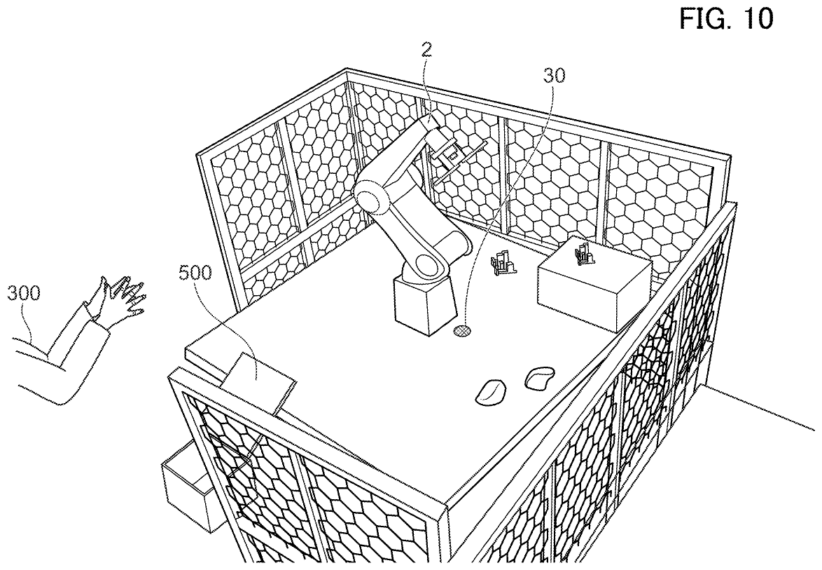

An example related to the processing flow (S1) is described with reference to FIGS. 1-12. FIGS. 7-12 all illustrate scenes in which a user 300 teaches the robot 2 in the workspace. FIG. 7 illustrates an example of a document. FIG. 8 illustrates a scene related to identification of a document. FIG. 9 illustrates a scene related to complementation of a workpiece. FIGS. 10-12 all illustrate scenes related to complementation of a target position.

In the example of FIG. 7, a document 200 is represented by two-dimensional codes positioned on a board. For example, the user creates the document 200 by positioning, on a board, magnet sheets on which two-dimensional codes are written. Four two-dimensional codes positioned at four corners of the board are marks for positioning the camera 20 to capture the entire board. In this example, the document 200 is composed of two-dimensional codes (210, 220, 230, 240) indicating syntaxes and two-dimensional codes (211, 212) indicating variables. The two-dimensional code 210 indicates a syntax “Place <Object A> at <Place P>.” In relation to this two-dimensional code 210, the two-dimensional code 211 indicating a variable “Object A” and the two-dimensional code 212 indicating a variable “Place P” are positioned. The two-dimensional code 220 indicates a syntax “The object is in front.” The two-dimensional code 230 indicates a syntax “End the task when no object is found.” The two-dimensional code 240 indicates a syntax “Work quickly.”

In the scene illustrated in FIG. 8, the inquiry part 11 inquires about a document (S111). The user 300 presents the document 200 on a board to the camera 20 in response to the inquiry. The identification part 12 identifies the document 200 from an image of the camera 20 (S112). The definition part 15 defines a task based on the document 200. The robot control part 14 starts execution of the task (S114). For example, the robot control part 14 starts the task by causing the robot 2 to assume an inquiry posture for inquiring the user about a reference object.

In the scene illustrated in FIG. 9, the inquiry part 11 inquires about a reference object (S121). The user 300 presents a reference object 400 to the camera 20 in response to the inquiry. The identification part 12 identifies a feature quantity of the reference object 400 from an image of the camera 20 (S122). The complementation part 16 sets a workpiece based on the feature quantity and complements the workpiece as at least a part of the task (S124).

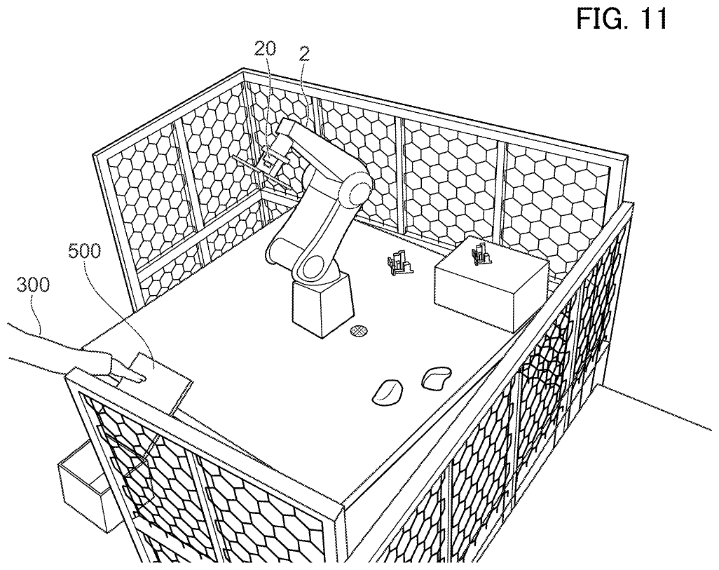

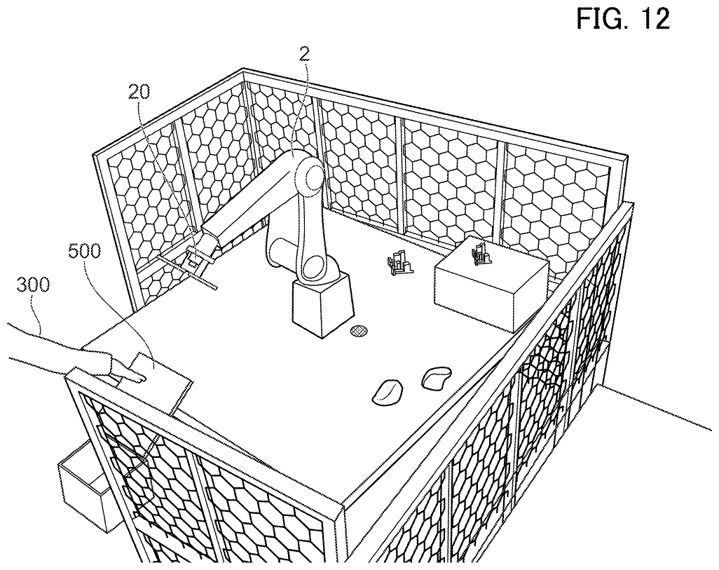

The scene illustrated in FIG. 10 illustrates a scene where the user 300 claps his/her hands for changing the orientation of the camera 20. The inquiry part 11 inquires about a target position (S131). In response to the inquiry, the user 300 claps his/her hands near an inclined plane 500 on which the workpiece is to be placed. The identification part 12 estimates a direction of the sound acquired from the speakerphone 30 and controls the robot 2 to orient the camera 20 toward the direction (S132). As illustrated in FIG. 11, after the orientation of the camera 20 is changed, the user 300 points, with his/her hand, to the inclined plane 500 as the target position. The identification part 12 identifies the hand shape from an image of the camera 20 (S133) and estimates the target position based on the hand shape (S135). As illustrated in FIG. 12, the identification part 12 determines that the camera 20 is not close to the target position and moves the camera 20 toward the target position (S136 and S137). In the example of FIG. 12, the identification part 12 controls the robot 2 to move the camera 20 towards the target position. After that, when it is determined that the camera 20 has approached the target position, the complementation part 16 complements the target position as at least a part of the task (S138).

After that, the robot control part 14 controls the robot 2 to execute the complemented task (S14). According to a command signal from the robot control part 14, the robot 2 searches for the workpiece in the workspace, grabs the found workpiece, and places the workpiece on the inclined plane 500, which is the target position. The workpiece is housed in a box below the inclined surface 500

### Modified Embodiments

In the above, the embodiment of the present disclosure has been described in detail. However, the technical matters of the present disclosure are not limited to the above embodiment. The technical matters of the present disclosure can be modified in various ways within a scope that does not deviate from the spirit of the present disclosure.

Defining a task may be a process that sets an entire task. In this case, complementation of a task by the complementation part is unnecessary. The robot control part controls the robot such that the robot executes the defined task. When the user presents a predetermined hand shape to the camera in place of the document, the definition part may acquire an entire task from the storage part as a task part corresponding to the hand shape and redefine the task as it is. In this case, the robot control part controls the robot such that the robot executes the redefined task.

The hardware structure of the system is not limited to a mode in which the functional modules are realized by executing a program. For example, at least some of the above-described functional modules may be realized using logic circuits specialized for the functions or may be realized using ASICs (Application Specific Integrated Circuits) in which the logic circuits are integrated.

The processing procedure of the method executed by at least one processor is not limited to the above example. For example, some of the steps or processes described above may be omitted, or the steps may be executed in a different order. Further, any two or more of the steps described above may be combined, or some of the steps may be modified or deleted. Or, in addition to the above steps, other steps may be executed.

When comparing relative magnitudes of two numerical values in a computer system or computer, either of two criteria of “equal to or larger than” and “larger than” may be used, and either of two criteria of “equal to or less than” and “less than” may be used.

A robot control system according to an embodiment of the present invention includes an inquiry part that executes an inquiry to a user while a robot is executing a task; an identification part that identifies an action of the user in response to the inquiry using a sensor; a complementation part that complements at least a part of the task based on the identified action; and a robot control part that controls the robot such that the robot executes the complemented task.

Since at least a part of the task being executed by the robot is complemented based on the action of the user identified using the sensor, a teaching load of the user can be reduced. Since the action of the user is identified using the sensor, the user can quickly become familiar with teaching the robot without having to learn how to operate an input-output device. Further, since an input-output device is not needed, as a result, it can be expected that a system structure is simplified and a development cost of the system is reduced.

In robot control system, the sensor may be a camera, the identification part extracts, from an image captured by the camera, a recognition target set in advance for the action, and identifies the action based on the extracted recognition target.

Since the action of the user is identified using the camera, the user can perform teaching through a natural action such as performing an action toward the camera. Further, since the recognition target necessary for identifying the action is set in advance, the recognition target can be more reliably extracted from the image. As a result, the action can be more reliably identified.

In the robot control system, the identification part may move the camera according to a preceding action performed by the user before the action and extracts the recognition target from the image captured by the camera that has moved.

Since the camera for capturing an image of the recognition target automatically moves according to the action of the user, the teaching load of the user can be further reduced.

In the robot control system, the camera may be mounted on the robot, the preceding action may include a sound emitted by the user, and the identification part may orient the camera in a direction in which the sound is emitted.

Since the camera faces the direction of the sound emitted by the user, the user can easily orient the camera toward a desired position, and, as a result, the teaching load of the user can be further reduced.

In the robot control system, the camera may be mounted on the robot, the identification part may cause the robot to operate such that the camera approaches toward the recognition target and extract the recognition target from an image captured by the camera that has approached the recognition target.

Since the camera approaches the recognition target, the recognition target necessary for identifying the action can be more reliably extracted. In addition, by causing the robot to operate such that the camera approaches the recognition target, it is possible to show the user the situation in which the robot is trying to identify the action of the user. As a result, it is possible to visually convey to the user that interactive teaching is being performed.

In the robot control system, wherein the identification part may cause the robot to operate such that the recognition target is positioned at a center of a field of view of the camera.

Since the camera can reliably capture the recognition target, the action of the user can be more reliably identified.

In the robot control system, the recognition target may a hand of the user, and the identification part may identify a shape of the hand extracted from the image as the action.

Since the hand of the user is processed as a recognition target, the user can easily teach using his/her own hand.

In the robot control system, the complementation part may complement a target position of the task executed by the robot as at least a part of the task based on the shape of the hand.

The target position of the task can be easily instructed to the robot.

In the robot control system, the identification part may extract a first shape of the hand from a first image and identify the first shape as the action, execute an additional inquiry to the user regarding whether or not to confirm the identified action, and extract a second shape of the hand in response to the additional inquiry from a second image, and confirm the identified action, and the complementation part may complement the at least a part of the task based on the confirmed action.

Before an identified action of the user is adopted, an inquiry for confirming the action is executed. Therefore, it is possible to give the user an opportunity to reconsider the action and reduce the probability of incorrect teaching.

The robot control system may further include a storage part that stores at least a part of the complemented task as a task part. The complementation part may acquire the task part from the storage part when the identified action corresponds to a hand shape set in advance, and the robot control part may control the robot such that the robot executes a task including the task part.

At least a part of a task previously used is acquired from the storage part and used. Therefore, the user can easily convey a previous instruction to the robot again.

In the robot control system, the identification part may extract a reference object presented by the user from the image and identify a feature quantity of the reference object as the action, and the complementation part may complement a workpiece processed by the robot as at least a part of the task based on the feature quantity.

The task is defined by complementing at least a part of the task based on a feature quantity of the reference object. Therefore, it is possible to easily teach a workpiece to be processed by the robot. Since a feature quantity of a reference object is used, various workpieces can be processed by the robot as long as the workpieces each have a feature quantity. In other words, since the user only needs to convey an abstract instruction regarding a workpiece to the robot, the teaching load can be reduced. When the feature quantity is a color, appearance of the color in the workspace is identified as the feature quantity. Therefore, by absorbing a difference in color appearance caused by optical characteristics such as a light quantity, it is possible to reliably identify a workpiece in each workspace.

The robot control system may further include a definition part that defines the task. The inquiry part may inquire the user about a document indicating the task, the definition part may define the task based on the document presented by the user, and the complementation part may complement at least a part of the defined task based on the identified action.

Since a task is defined simply by the user presenting a document, the teaching load of the user can be reduced.

In the robot control system, the document may include a syntax and a variable regarding the task, the definition part defines the task based on the syntax, the inquiry part may execute the inquiry to the user regarding the variable, the identification part may identify the action of the user in response to the inquiry, and the complementation part may complement a value to be assigned to the variable based on the identified action.

A document that indicates a task by a syntax and a variable is used, and a task is first defined based on the syntax. Subsequently, the task is complemented by assigning a value to the variable based on an action of the user. In this way, by setting a task in a step-by-step manner, even when the task is complex, the task can be easily taught to the robot.

In the robot control system, the inquiry part may cause the robot to operate such that the robot assumes an inquiry posture, which is a posture corresponding to the inquiry, and execute the inquiry after the robot assumes the inquiry posture.

Since the robot assumes a specific posture before inquiring the user, it is possible to visually and clearly convey to the user the timing at which he/she should take action.

A robot control system according to an embodiment of the present invention includes an inquiry part that inquires a user about a document indicating a task to be executed by a robot, an identification part that identifies the document presented by the user from an image captured by a camera, a definition part that defines the task based on the identified document, and a robot control part for that controls the robot such that the robot executes defined task.

Since a task is defined simply by the user presenting a document, the teaching load of the user can be reduced. Since the document is identified using the camera, the user can easily teach the robot without having to learn how to operate an input-output device. Further, since an input-output device is not needed, as a result, it can be expected that a system structure is simplified and a development cost of the system is reduced.

A robot control method to be executed by a robot control system including at least one processor according to an embodiment of the present invention includes executing an inquiry to a user while a robot is executing a task, identifying an action of the user in response to the inquiry using a sensor, complementing at least a part of the task based on the identified action, and controlling the robot such that the robot executes the complemented task.

Since at least a part of the task being executed by the robot is complemented based on the action of the user identified using the sensor, a teaching load of the user can be reduced. Since the action of the user is identified using the sensor, the user can quickly become familiar with teaching the robot without having to learn how to operate an input-output device. Further, since an input-output device is not needed, as a result, it can be expected that a system structure is simplified and a development cost of the system is reduced.

A robot control program according to an embodiment of the present invention causes a computer to execute an inquiry to a user while a robot is executing a task, identify an action of the user in response to the inquiry using a sensor, complement at least a part of the task based on the identified action, and control the robot such that the robot executes the complemented task.

Since at least a part of the task being executed by the robot is complemented based on the action of the user identified using the sensor, a teaching load of the user can be reduced. Since the action of the user is identified using the sensor, the user can quickly become familiar with teaching the robot without having to learn how to operate an input-output device. Further, since an input-output device is not needed, as a result, it can be expected that a system structure is simplified and a development cost of the system is reduced.

Japanese Patent No. 5549749 describes a robot teaching system for suppressing an increase in user operation burden. This system includes a teaching tool that includes an operation part to be operated by a user for specifying a teaching position, a measurement part that measures a position and a posture of the teaching position specified by the teaching tool, and a control part that determines a teaching position of a robot based on the position and posture.

A mechanism for easily teaching a task to a robot is desired.

A robot control system according to one aspect of the present disclosure includes: an inquiry part that executes an inquiry to a user while a robot is executing a task; an identification part that identifies an action of the user in response to the inquiry using a sensor; a complementation part that complements at least a part of the task based on the identified action; and a robot control part that controls the robot such that the robot executes the complemented task.

A robot control method according to one aspect of the present disclosure is to be executed by a robot control system including at least one processor, and includes: executing an inquiry to a user while a robot is executing a task; identifying an action of the user in response to the inquiry using a sensor; complementing at least a part of the task based on the identified action; and controlling the robot such that the robot executes the complemented task.

A robot control program according to one aspect of the present disclosure causes a computer to execute: executing an inquiry to a user while a robot is executing a task; identifying an action of the user in response to the inquiry using a sensor; complementing at least a part of the task based on the identified action; and controlling the robot such that the robot executes the complemented task.

According to one aspect of the present disclosure, a task can be easily taught to a robot.

Obviously, numerous modifications and variations of the present invention are possible in light of the above teachings. It is therefore to be understood that within the scope of the appended claims, the invention may be practiced otherwise than as specifically described herein.

1. A robot control system, comprising:
processing circuitry configured to generate an inquiry for a user while a robot is executing a task, identify an action of the user in response to the inquiry using a sensor, complement at least part of the task based on the identified action, and control the robot such that the robot executes the complemented at least part of the task.

2. The robot control system according to claim 1, wherein the sensor is a camera, and the processing circuitry is configured to extract, from an image captured by the camera, a recognition target set in advance for the action, and identify the action based on the extracted recognition target.

3. The robot control system according to claim 2, wherein the processing circuitry is configured to move the camera according to a preceding action performed by the user before the action and extract the recognition target from the image captured by the camera that has moved.

4. The robot control system according to claim 3, wherein the camera is mounted on the robot, the preceding action includes a sound emitted by the user, and the processing circuitry is configured to orient the camera in a direction in which the sound is emitted.

5. The robot control system according to claim 3, wherein the camera is mounted on the robot, the processing circuitry is configured to cause the robot to operate such that the camera approaches the recognition target and extract the recognition target from an image captured by the camera that has approached the recognition target.

6. The robot control system according to claim 5, wherein the processing circuitry is configured to cause the robot to operate such that the recognition target is positioned at a center of a field of view of the camera.

7. The robot control system according to claim 2, wherein the recognition target is a hand of the user, and the processing circuitry is configured to identify a shape of the hand extracted from the image as the action.

8. The robot control system according to claim 7, wherein the processing circuitry is configured to complement a target position of the task executed by the robot as the at least part of the task based on the shape of the hand.

9. The robot control system according to claim 7, wherein the processing circuitry is configured to extract a first shape of the hand from a first image and identify the first shape as the action, generate an additional inquiry for the user regarding whether or not to confirm the identified action, extract a second shape of the hand in response to the additional inquiry from a second image, and confirm the identified action, and complement the at least part of the task based on the confirmed action.

10. The robot control system according to claim 7, further comprising:
a memory that stores the complemented at least part of the task as a task part, wherein the processing circuitry is configured to acquire the task part from the memory when the identified action corresponds to a hand shape set in advance and control the robot such that the robot executes a task including the task part.

11. The robot control system according to claim 2, wherein the processing circuitry is configured to extract a reference object presented by the user from the image, identify a feature quantity of the reference object as the action and complement a workpiece processed by the robot as the at least part of the task based on the feature quantity.

12. The robot control system according to claim 1, wherein the processing circuitry is configured to define the task, inquire the user about a document indicating the task, define the task based on the document presented by the user, and complement at least part of the defined task based on the identified action.

13. The robot control system according to claim 12, wherein the document includes a syntax and a variable regarding the task, and the processing circuitry is configured to define the task based on the syntax, generate the inquiry for the user regarding the variable, identify the action of the user in response to the inquiry, and complement a value to be assigned to the variable based on the identified action.

14. The robot control system according to claim 1, wherein the processing circuitry is configured to cause the robot to operate such that the robot assumes an inquiry posture, which is a posture corresponding to the inquiry, and generate the inquiry after the robot assumes the inquiry posture.

15. A robot control system, comprising:
processing circuitry configured to generate an inquiry for a user about a document indicating a task to be executed by a robot, identify the document presented by the user from an image captured by a camera, define the task based on the identified document, and control the robot such that the robot executes the defined task.

16. A robot control method, comprising:
generating, by processing circuitry of a robot control system, an inquiry for a user while a robot is executing a task;
identifying, by the processing circuitry of the robot control system, an action of the user in response to the inquiry using a sensor;
complementing, by the processing circuitry of the robot control system, at least part of the task based on the identified action; and
controlling, by the processing circuitry of the robot control system, the robot such that the robot executes the complemented at least part of the task.

17. A non-transitory computer-readable storage medium including computer executable instructions that when executed by a computer, cause the computer to perform the method of claim 16.

18. The robot control system according to claim 6, wherein the recognition target is a hand of the user, and the processing circuitry is configured to extract a first shape of the hand from a first image and identify the first shape as the action, generate an additional inquiry for the user regarding whether or not to confirm the identified action, extract a second shape of the hand in response to the additional inquiry from a second image, and confirm the identified action, and complement the at least part of the task based on the confirmed action.

19. The robot control system according to claim 6, wherein the processing circuitry is configured to extract a reference object presented by the user from the image, identify a feature quantity of the reference object as the action, and complement a workpiece processed by the robot as the at least part of the task based on the feature quantity.

20. The robot control system according to claim 6, wherein the processing circuitry is configured to define the task, inquire the user about a document indicating the task, define the task based on the document presented by the user, and complement at least part of the defined task based on the identified action.
